(19) United States
(12) Patent Application Publication
(10) Pub. No.: US 2022/0413834 A1
(43) Pub. Date: Dec. 29, 2022

(54) SOFTWARE PLACEMENT SYSTEM, SOFTWARE PLACEMENT DEVICE, SOFTWARE PLACEMENT METHOD, BASE COMPUTER AND PROGRAM

(71) Applicant: Nippon Telegraph and Telephone Corporation, Tokyo (JP)

(72) Inventors: Hirofumi NOGUCHI, Musashino-shi, Tokyo (JP); Kyota HATTORI, Musashino-shi, Tokyo (JP); Misao KATAOKA, Musashino-shi, Tokyo (JP); Takuma ISODA, Musashino-shi, Tokyo (JP)

(21) Appl. No.: 17/780,303

(22) PCT Filed: Nov. 29, 2019
(86) PCT No.: PCT/JP2019/046715

§ 371 Date: May 26, 2022

(51) Int. Cl. G06F 8/65; G06F 11/34

(52) U.S. Cl. CPC G06F 8/65; G06F 11/3495

(57) ABSTRACT

A software placement device of a software placement system includes an information acquiring unit configured to acquire a finally-found location and a finally-found time, a deployment destination determining unit configured to calculate a data presence probability indicating a probability of a search target being detected at a certain time using the finally-found location and the finally-found time, to calculate a total cost using the data presence probability calculated and a computational cost and a network cost of each of base computers, and to select a base computer and a time interval for which the calculated total cost is a minimum, and a software distributing unit configured to distribute software to the selected base computer and transmit an analysis instruction for data of the selected time interval to the selected base computer.

### TECHNICAL FIELD

The present invention relates to a software placement system, a software placement device, a software placement method, a base computer, and a program that place software for data analysis in a plurality of computing resources connected to a network.

### BACKGROUND ART

Today, the Internet of Things (IoT) continues to expand rapidly, and a wide variety and a large number of devices are being connected to a network. Thus, utilization of vast data generated by such devices is expected. For example, a large number of monitoring cameras have already been installed on streets and in stores, and the monitoring cameras record daily videos. Video data can be utilized not only for use at the time of occurrence of an accident or an event but also for various uses such as a traffic volume census, analysis of store customers, and searching for missing children. For example, in a service such as a missing child search for searching for specific data from vast data and using the data, minimizing a computational cost and a data communication cost required for a data search is an issue.

For this issue, a technique for searching real-time data of IoT devices based on a system model called edge computing performing a data analysis process using a computer present in the physical vicinity of a device that generates data has been proposed (see NPL 1). In this technique, software required for a data search is distributed to an edge computer, and the software checks whether desired data is present. For example, in the case of the missing child search, software for recognizing face images of a search target is distributed, and an image recognition process is performed on data generated by a camera device connected to an edge computer. In this way, data communication is localized, and thus costs required for the data communication and a communication delay can be reduced by performing the data analysis process required for the search using the edge computer.

On the other hand, in an edge computing environment, computers are separated for each of installation bases such as buildings, and thus an amount of computing resources of each base is limited. Thus, when multiple data searches are simultaneously performed in the same base, a load exceeding a computational capacity of the computer may be easily applied, which prevents real-time data searches being performed. In other words, it is not permitted for many services to simply distribute data search software to computers of all the bases and cause the data search software to be executed therein.

As described above, when data analysis software used for a data search is distributed to an edge computer, it is necessary to select an appropriate edge computer from among a large number of candidates present in a broad area.

### CITATION LIST

### Non Patent Literature

NPL 1: Hirofumi Noguchi, et al., “Distributed Search Architecture for Object Tracking in the Internet of Things,” IEEE Access, vol. 6, pp. 60152-60159, 2018

### SUMMARY OF THE INVENTION

### Technical Problem

As a technique for deploying data analysis software in edge computers, a technique using a data trend that occurs in each base may be considered. Here, the base is, for example, a single event area, a park, an inside of a specific building, or one section of a street, and serves as a management unit of the edge computer. The data trend is, for example, information that is statistically derived from past results such as results indicating that there is a high likelihood of passersby being captured by street cameras used in the day time, and there is a high likelihood of persons of a specific age and a specific sex being captured by monitoring cameras of stores. By calculating an expected value of finding data for each location based on such data trends, the number of search bases required for finding target data is decreased and a search time is shortened, and thereby an efficiency of the overall system can be improved.

A premise of the technique described above is that an expectation value for finding target data is calculated from data search results in the past. However, in a real-time search service for a moving search target (for example, a specific individual such as a missing child, a fugitive criminal, or the like), a situation in which search results of a corresponding person (a missing child or the like) for each base have not been acquired in advance as statistical information may be considered. For example, in most cases, a data trend of specific individual children who have become lost is not stored as statistical information, and there is no past result data that can be used. In other words, in the technique described above, for a search target for which there is no result data, data analysis software cannot be efficiently deployed in edge computers.

The present invention has been made in view of the above problems, and an object thereof is to efficiently deploy software used for data analysis in computers of bases in a case in which a search for data of a search target having no result data is to be performed.

### Means for Solving the Problem

According to the present invention, there is provided a software placement system including: base computers located in a plurality of areas; and a software placement device configured to deploy software for analyzing data collected from devices inside the areas in the base computers, wherein the software placement device includes: an information acquiring unit configured to acquire a finally-found location indicating a location at which a search target has been last found and a finally-found time indicating a time at which the search target has been last found; a deployment destination determining unit configured to calculate a data presence probability indicating a probability of the search target being detected in the data at a certain time using the finally-found location and the finally-found time, to calculate a total cost using the calculated data presence probability and a computational cost and a network cost of each of a plurality of the base computers, and to select a base computer and a time interval for searching for the search target for which the calculated total cost is a minimum; and a software distributing unit configured to distribute the software to the selected base computer and to transmit an analysis instruction for data of the selected time interval to cause the selected base computer to execute a search for the search target in the selected time interval, and each of the base computers includes: a data collecting unit configured to collect data from devices inside an area; and a data analyzing unit configured to execute a search for the search target using the software for the data of the selected time interval indicated in the analysis instruction in a case in which the software is distributed to the corresponding base computer.

### Effects of the Invention

According to the present invention, in a case where finding of data of a search target having no result data is performed, software used for data analysis can be efficiently deployed in base computers.

### BRIEF DESCRIPTION OF DRAWINGS

FIG. 1 is a diagram illustrating an overall configuration of a software placement system according to an embodiment.

FIG. 2 is a diagram illustrating a state space used for conceptually describing software deployment into a base according to the embodiment.

FIG. 3 is a diagram illustrating a data presence probability according to the embodiment.

FIG. 4 is a diagram illustrating a data value according to the embodiment.

FIG. 5 is a flowchart illustrating a flow of process executed by a software placement device according to the embodiment.

FIG. 6 is a hardware configuration diagram illustrating an example of a computer that implements functions of a software placement device and a base computer according to the embodiment.

### DESCRIPTION OF EMBODIMENTS

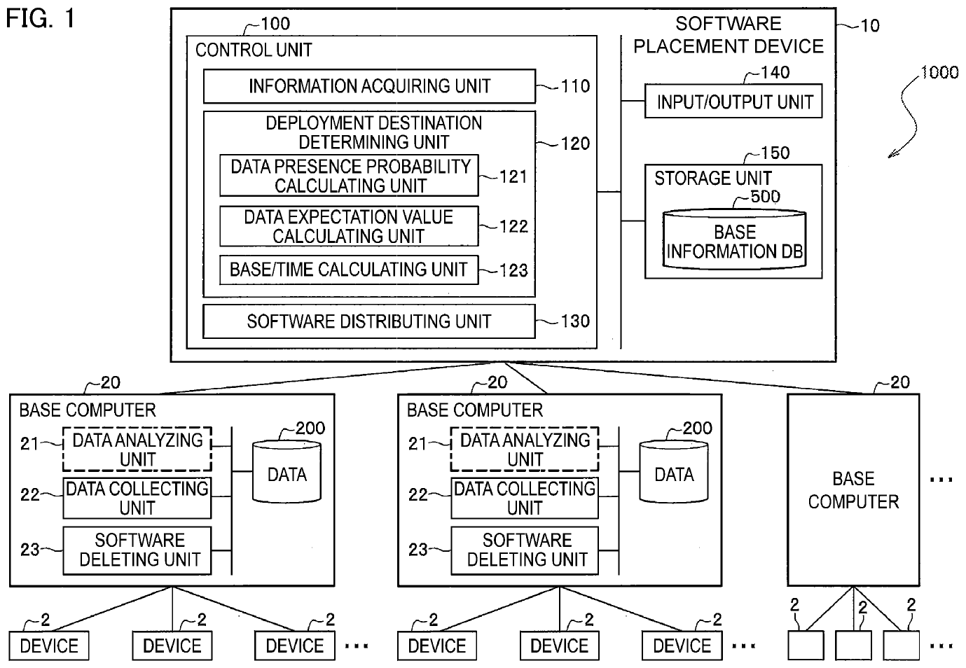

First, an overall configuration of a software placement system 1000 according to this embodiment (see FIG. 1) and parameters introduced in the present invention is described.

Overall Configuration

FIG. 1 is a diagram illustrating an overall configuration of a software placement system 1000 according to this embodiment.

As shown in FIG. 1, the software placement system 1000 includes base computers 20 that are communicatively connected to a plurality of devices 2 and collect data from the devices 2; and a software placement device 10 that is communicatively connected to the base computers 20 and distributes software used for data analysis to the base computer 20 determined in a deployment destination determining process described below.

Here, the base computers 20 each according to this embodiment is a computer, for example, deployed in a base provided for each of management units such as one event area, a park, an inside of a specific building, one section of a street, and the like. Data generated by the devices 2 (for example, video data, sensor data, and the like) is transmitted to and stored in a computer (the base computer 20) that manages an area in which the devices 2 are located.

The software placement device 10 according to this embodiment determines a base computer 20 in which the software is to be deployed using parameters such as a data presence probability, a computational cost of the computer, a network cost, and the like, which are described below. In addition, the software placement device 10 is configured to determine a base computer 20 that becomes a deployment destination by introducing a parameter named “data value” with higher accuracy.

Parameters

Before description of a specific configuration of the software placement device 10 and the like according to this embodiment, details of parameters introduced in the present invention and technical ideas of introducing the parameters are described.

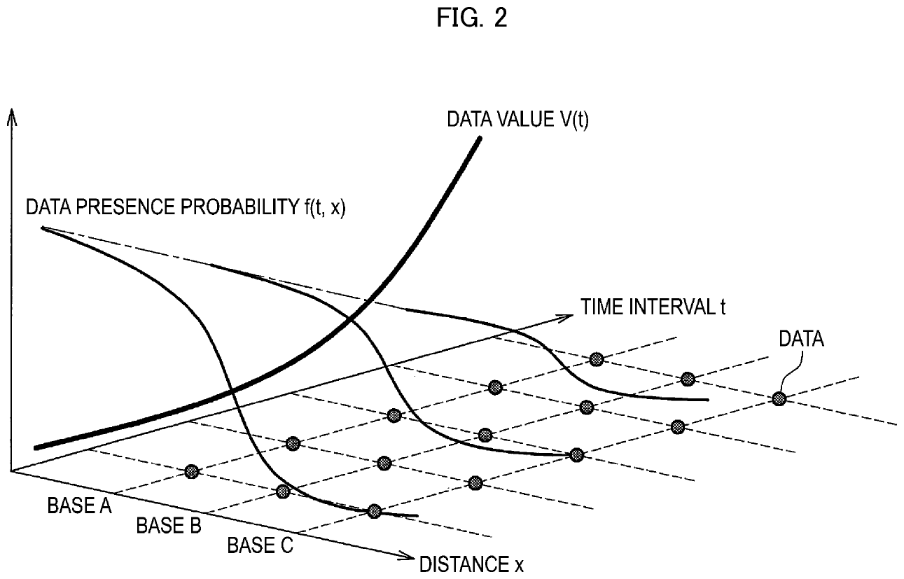

FIG. 2 is a diagram illustrating a state space used for conceptually describing software deployment into a base (the base computer 20) according to this embodiment.

In this embodiment, as shown in FIG. 2, a space having as its axes a physical distance between the bases (distance x) and a time interval (time interval t) is supposed. Points that are discretely arranged each represent data collected in a certain time frame at a certain base. By selecting an arbitrary base and an arbitrary time interval (time frame) and distributing the software for data analysis to a base computer 20 at an arbitrary base and an arbitrary time interval (time frame) selected, the software placement device 10 causes the base computer 20 to execute data analysis and determines whether or not corresponding data is target data. Depending on a result of the determination, in a case in which the data is the target data (in a case in which the target data has been found), the software placement device 10 determines that the search is successful and ends the process. On the other hand, in a case in which the data is not the target data (in a case in which the target data has not been found), the software placement device 10 newly selects other data and repeats the same process. A computational cost is required for the execution of the data analysis process using software, and therefore it is a goal of this embodiment to find target data with fewer selections.

Under such a premise, by introducing axes of a data presence probability, a data value, a computational cost of a computer (not illustrated in FIG. 2), and a network cost (not illustrated in FIG. 2) illustrated in FIG. 2 in the space described above (the space having as its axes a distance (between bases) and a time interval), and comprehensively analyzing these parameters, a deployment place of the software (the base computer 20) is determined.

Data Presence Probability

A data presence probability f(x) is acquired by representing a presence probability of a search target as a function of a distance (x). As the presence probability of the search target moving in a time series, a normal distribution represented by the following Equation (1) is used in this embodiment. Here, “μ” represents a location at which a search target is last found. In addition, “σ” in Equation (1) is, for example, given by Equation (2).

$$[ Math . 1 ]$$

$$f ( x ) = \frac{1}{\sqrt{2 {πσ}^{2}}} exp ( - \frac{{( x - μ )}^{2}}{2 {σ}^{2}} ) \qquad Equation ( 1 )$$

$$σ = α ⋆ ( t - t\_last ) \qquad Equation ( 2 )$$

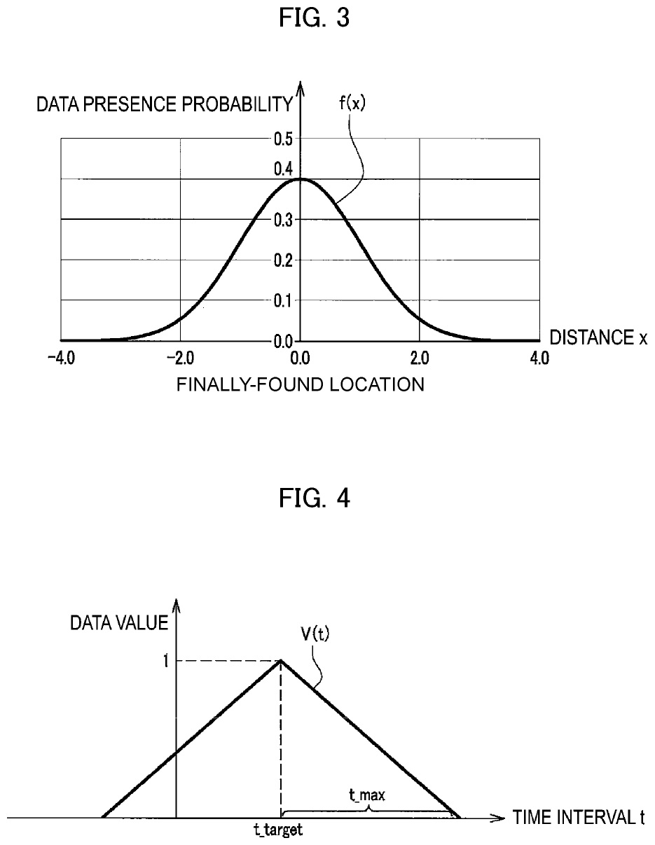

The normal distribution represented by Equation (1) is shown in FIG. 3. In FIG. 3, the horizontal axis represents a distance, and discrete points of the distance correspond to locations of bases. In FIG. 3, the vertical axis represents a presence probability of target data (a data presence probability).

An average “μ” f of the normal distribution (the center of the graph) is the location of a base at which a corresponding search target is last found (“finally-found location” in FIG. 3). The “finally-found location” is a location at which a search target is last found before a deployment destination determining process described below, and is a location at which a search target is newly found (details thereof is described below) that is calculated during the deployment destination determining process. A dispersion of the normal distribution is represented using a value calculated based on an elapsed time interval from a time at which a search target is last found (hereinafter referred to as a “finally-found time”). For example, a value calculated using Equation (2) is used for the dispersion. By using Equation (2), a presence probability of a search target at a certain time t can be calculated using a time (t_last) at which the search target is last found before the time t. In addition, this “finally-found time” is a time at which the search target is last found before the deployment destination determining process described below, and a time at which the search target is newly found (details thereof is described below) that is calculated during the deployment destination determining process.

In addition, “α” in Equation (2) is a weight used for adjusting a numerical value, and represented using an arbitrary number. By using Equations (1) and (2), when an elapsed time interval from a time at which a search target is last found becomes longer, being able to move to a farther location can be reflected in the presence probability. On the other hand, in a case in which the elapsed time interval from the time at whichthea search target islast found is extremely short, a presence location of the search target can be regarded as zero (within the area of the base at which the search target is last found) because of a physical speed limit.

According to the present invention, this data presence probability is updated with a trigger of finding data. It means that there is a possibility of data found at a time that is not originally intended as a finding time of a search target also contributes to finding of “target data” (data in which a search target is found at a target time (in a target time interval)) because the data found at the time changes the data presence probability. For example, in a person search service, the presence probability at a time at which a long time interval has elapsed after a target person has been last found is leveled at a low probability at all the bases, and thus a use value thereof is low. On the other hand, the presence probability at a time close to a finally-found time represents a remarkable trend (a higher probability), and thus there is a high possibility of founding data by taking it into account.

In this embodiment, regardless of a time (time interval) at which data is found, data whose search target is found by the data analysis is referred to as “found data.”

Although the data that can be found (found data) at that time is data at a time different from that of the target data, by finding this data, “μ” (a location at which the search target is last found, i.e., finally-found location) and “t_last” (a time at which the search target is last found, i.e., finally-found time) can be updated. This allows sequentially updating the data presence probability with lapse of time, resulting an efficient search for target data.

Data Value

By sequentially updating the data presence probabilities with time using the technique described above, a search for the target data can be performed more efficiently than a conventional search. However, the process is performed following lapse of time, and thus it may be assumed that the computational cost increases by an amount corresponding to processes that are repeated until the target data is reached. By taking this into account, the concept of “data value” is introduced as a parameter for reducing the number of times by which the data processing is repeated.

A data value is an index value that decreases in proportion to a time difference from the time of the target data. Adding the data value as a parameter brings an effect of inhibiting simple selection of only data with a high data presence probability ignoring the number of processes required for data analysis.

As shown in the following Equation (3), the data value V(t) is represented, for example, as a value that decreases in proportion to a time difference from the time of the target data. Equation (3) is illustrated in FIG. 4.

$$[ Math . 2 ]$$

$$V ( t ) = 1 - \frac{( {t}_{\_target} - t )}{( {t}_{\_target} - t\_max )} \qquad Equation ( 3 )$$

The “t_target” in Equation (3) and FIG. 4 indicates a time interval of data that is a target (hereinafter referred to as a “target time interval”). For example, as the target time interval, a current time interval (time) may be designated, or a certain time interval (time) in the past may be designated. The “t_max” indicates a maximum deviation time interval that is allowed as a search range from a designated time interval of the target data (a target time interval) (hereinafter simply referred to as a “deviation time interval”). For example, when the “t_max” is designated as 60 minutes, data between 60 minutes before/after a designated time interval of the target data (a target time interval) is an analysis target.

Data Expectation Value

A value acquired by integrating the data presence probability with the data value described above is referred to as a “data expectation value.” For example, when Equations (1) and (2) are used for a data expectation value, and Equation (3) is used for a data value, a data expectation value E(t, x) is obtained by using the following Equation (4).

$$[ Math . 3 ]$$

$$E ( t , x ) = \frac{1}{\sqrt{2 {x ( α ( t - t\_last ) )}^{2}}} exp ( - \frac{{( x - μ )}^{2}}{2 {( α ( t - t\_last ) )}^{2}} ) + 1 - \frac{( {t}_{\_target} - t )}{( {t}_{\_target} - t\_max )} \qquad Equation ( 4 )$$

In a case in which the data value is not taken into account as a parameter, the value of the data presence probability f(t, x) obtained from Equations (1) and (2) is directly used as the data expectation value E(t, x). The data expectation value E(t, x) in that case is represented by Equation (5).

$$[ Math . 4 ]$$

$$E ( t , x ) = f ( t , x ) = \frac{1}{\sqrt{2 {x ( α ( t - t\_last ) )}^{2}}} exp ( - \frac{{( x - μ )}^{2}}{2 {( α ( t - t\_last ) )}^{2}} ) \qquad Equation ( 5 )$$

Total Cost

A concept of “total cost” is introduced as a cost acquired by taking into account a computational cost Cc(x) and a network cost Cn(x) for each base in addition to the data expectation value. Here, the computational cost Cc(x) is a cost that is different from each base and required for using a computer (for example, a cost for occupying computer resources per unit time interval and the like). In addition, the network cost Cn(x) is a cost that is different from each base and relates to data transmission (for example, a cost relating to occupancy of a network line and the like). The computational cost and the network cost may be configured as static values for each base on installation of facilities, or may be dynamically calculated in view of a current (at a calculation time) load situation.

The total cost C(t, x) can be obtained, for example, as a value acquired by subtracting the data expectation value from a sum of the costs, as represented in the following Equation (6). Here, β is an arbitrary number (weight).

[Math. 5]

C(t,x)=Cc(x)+Cn(x)−βE(t,x) Equation (6)

The software placement device 10 selects a base (x) and a time (t) for which the total cost (C) calculated using Equation (6) is minimized and determines them respectively to be a deployment destination of the software used for data analysis and a time interval of the search target (“deployment destination determining process” described below). With this process, the software placement device 10 can implement effective deployment of software taking into account a probability and a cost for data finding.

Configuration of Apparatus

Next, a specific configuration of the software placement system 1000 including the software placement device 10 and a plurality of the base computers 20 according to this embodiment is described with reference to FIG. 1.

Base Computer

The base computer 20 is a computer that collects and stores data from a plurality of the devices 2 located within a management unit configured for each base. Here, the device 2 is, for example, a camera device (a monitoring camera or the like) that acquires video data used for a video search service. Depending on details of a service, the device 2 may be a sound sensor, a temperature sensor, or any other sensor device.

This base computer 20 is constituted mainly by a computer that includes a control unit, an input/output unit, and a storage unit (none of which is illustrated). At normal times (when no data analysis instruction is received), the base computer 20 does not include the software for data analysis. When the base computer 20 receives the software for data analysis and an instruction for analyzing data for a selected time interval from the software placement device 10, the base computer 20 is configured to analyze the data.

As illustrated in FIG. 1, the base computer 20 includes a data collecting unit 22 and a software deleting unit 23 in a control unit. The data collecting unit 22 collects data 200 from each device 2 and stores the collected data 200 in the storage unit for a predetermined period. The data 200 may be stored in a storage server accommodated in a separate casing in place of the storage unit of the base computer 20.

In addition, the base computer 20 implements a function of a data analyzing unit 21 by receiving the software for data analysis from the software placement device 10 in relation with the data analysis of the stored data 200.

When receiving an instruction for analysis of data designating a time interval (a time frame) (“data of a selected time interval”, which is described below) from the software placement device 10, this data analyzing unit 21 performs data analysis of the data of the corresponding time interval (the time frame) in the data 200 stored in its own storage unit (not illustrated). Then, the data analyzing unit 21 transmits result information indicating whether or not the target data has been found to the software placement device 10.

The software deleting unit 23 deletes the software for data analysis (a data analyzing unit 21) distributed from the software placement device 10 based on a predetermined software deletion logic. For example, this predetermined software deletion logic may be a logic of storing software for a predetermined time interval and deleting the software after elapse of a predetermined time interval or a logic of deleting the software at each data analysis. Alternatively, the predetermined software deletion logic may be a logic that the received software is deleted by the base computer 20 (the software deleting unit 23) as a trigger with receiving information indicating end of a series of processes for the search target from the software placement device 10. The predetermined software deletion logic for deleting received software is configured in the base computer 20 in advance.

The base computer 20 according to this embodiment can receive and store the software only when the data analysis is needed and perform the data analysis only on data of a time interval for which the analysis instruction has been received, which results in reduction of the computational load of the base computer 20e. Further, when the data analysis becomes unnecessary, the software deleting unit 23 deletes the distributed software, and thus computational resources (a central processing unit (CPU), a memory, and the like) of the base computer 20 can be effectively used for processes relating to other services and the like.

Software Placement Device

Next, a specific configuration of the software placement device 10 is described. The software placement device 10 according to this embodiment is configured to taking into account the parameters such as “data presence probability”, “data expectation value”, “cost”, and the like, to select a base computer 20 at which a (total) cost for a data search is the lowest when deploying the software for the data search in the base computer 20.

As illustrated in FIG. 1, the software placement device 10 is configured to include a control unit 100, an input/output unit 140, and a storage unit 150.

The input/output unit 140 is composed of a communication interface for transmitting/receiving information to/from each base computer 20 and the like and an input/output interface for transmitting/receiving information to/from input devices such as a touch panel, a keyboard, and the like and output devices such as a monitor and the like.

The storage unit 150 is composed of a flash memory, a hard disk, a random access memory (RAM), and the like. This storage unit 150 stores a base information database (DB) 500, and temporarily a program for implementing each function of the control unit 100 and information that is necessary for process performed by the control unit 100. In addition, the storage unit 150 stores constants that are necessary for a deployment destination determining process, such as a deviation time interval (t_max), a constant used for calculation of a data presence probability (weight “α”), a constant used for calculation of a total cost (weight “β”), and the like in advance. Furthermore, the software that is a distribution target may be stored in this storage unit 150 in advance, or a software distributing unit 130 described below may preform a control such that the software stored in an external apparatus is distributed to the base computer 20.

In association with identification information of each base computer 20, there are stored location information of the base computer 20 (including information stored in the base computer 20 and relating to a management area in which each device 2 is located (a predetermined area)), information of a computational cost (Cc) of the base computer 20, and information of a network cost (Cn) of the base computer 20 in the base information DB 500.

Note that the information of the computational cost (Cc) and the network cost (Cn) of each base computer 20 may be registered in advance as static information by a network management apparatus (not illustrated) or the like, or that the computational cost (Cc) and the network cost (Cn) of each base computer 20 depending on a load status of the current time point may be received from the network management apparatus (not illustrated) or the like and stored in the base information DB 500.

The control unit 100 is configured to control the overall process of the software placement device 10 and include an information acquiring unit 110, a deployment destination determining unit 120, and a software distributing unit 130.

The information acquiring unit 110 acquires designation information of target data that is a search target (hereinafter, referred to as “target data designation information”) from an external apparatus (for example, a network management apparatus or the like).

This target data designation information includes information indicating features of the search target, a time interval designating a time during which the target data should be found (hereinafter, referred to as “target time interval”), a location at which the search target has been last found (a finally-found location), and a time (“t_last”, finally-found time) at which the search target has been last found.

The search target is not limited to a person such as a missing child, a fugitive criminal, or the like and may be a pet such as a dog, a vehicle, a motor bicycle, a bicycle, or the like and is a unique target for which there is no (or a small amount of) result data that can be acquired as statistical information.

Here, “the information indicating features of a search target” (feature information of a search target) is information that is used to identify (search) the target data by the distributed software to analyze data. For example, in the case of a missing child search service, the feature information of the search target is information that indicates feature quantities of a body shape, a face, clothes, and the like of a missing child.

The “target time interval” is a time interval designated to find the target data of the search target and, for example, may be a current time or a time of a certain time point in the past. In addition, as the “target time interval,” a time frame that is one unit of a group of individual data in the data 200 stored in the base computer 20 (a predetermined time frame in data that is consecutive in a time series) may be designated. Furthermore, in a case where a certain time is designated in the “target time interval”, the base computer 20 sets data 200 of a predetermined time frame including the designated time as a search target.

The “location at which a search target was last found” (the finally-found location) may be location information of the search target itself at which the search target is last found or may be information specifying which base computer 20 manages an area (a predetermined area) in which the search target is found.

The “time at which a search target is last found” (“t_last”: finally-found time) is a time at which the search target is last found, and, as a search target whose data is to be found, a predetermined time frame including the corresponding time is designated.

The deployment destination determining unit 120 calculates parameters such as “data presence probability”, “data expectation value,” “cost”, and the like described above and performs a deployment destination determining process for determining a base computer 20 and a search time interval for which a total cost is minimum in a data search. In addition, in a case in which a base computer 20 that is the deployment destination finds data including a search target (found data) using the data analysis, but the time interval is different from the target time interval, the deployment destination determining unit 120 updates the time at which a search target is last found (“t-last”: finally-found time) with the time at which the data (the found data) is found and updates the location at which a search target is last found (the finally-found location) with the location of the base computer 20 that is the deployment destination, and then, repeats the deployment destination determining process. This allows the data presence probability to be updated and a search for target data at a target time interval to be performed more efficiently.

The deployment destination determining unit 120 is configured to include a data presence probability calculating unit 121, a data expectation value calculating unit 122, and a base/time calculating unit 123.

The data presence probability calculating unit 121 calculates a data presence probability based on Equations (1) and (2) described above by using the finally-found location and the finally-found time (t_last) included in the target data designation information acquired by the information acquiring unit 110.

In addition, the data presence probability calculating unit 121 acquires result information from the base computer 20 that has received the instruction for analyzing data of the selected time interval (time frame). In a case where data including the search target (found data) is found in the result information acquired from the base computer 20 but the selected time interval is different from the target time interval, the data presence probability calculating unit 121 updates the finally-found time with a time at which the found data has been found and updates the finally-found location with a location of the selected base computer 20 and calculates the data presence probability again.

On the other hand, in a case in which the data including the search target (found data) has not been found in the result information acquired from the base computer 20, the data presence probability calculating unit 121 excludes the selected time interval in the base computer 20 in which the found data has not been found in the data analysis from the selection target and calculates the data presence probability again.

The data expectation value calculating unit 122 calculates a data expectation value E (t, x) on a basis of Equation (4) by using the data presence probability calculated by the data presence probability calculating unit 121 and the data value calculated on a basis of Equation (3).

The designated time interval of the target data (“t_target”, target time interval) used for calculating the data value V(t) is information that is included in the target data designation information acquired by the information acquiring unit 110. In addition, the deviation time interval (“t_max”) is information that is configured in the storage unit 150 or the like in advance.

On the other hand, in a case in which the data value V (t) is not taken into account, the data expectation value calculating unit 122 directly uses the value of the data presence probability f(x, t) as the data expectation value E(t, x), as represented in Equation (5) described above.

The base/time calculating unit 123 calculates a total cost C(t, x) based on Equation (6) described above using the information of the data expectation value E(t, x) calculated by the data expectation value calculating unit 122 and the information of the computational cost Cc(x) and the network cost Cn(x) for each base stored in the base information DB 500 of the storage unit 150.

The base/time calculating unit 123 selects a base (x) and a time interval (t) for which the total cost C(t, x) is a minimum using Equation (6) to determine the base and the time that have been selected as a software deployment destination for data analysis and a time interval for a search target.

Then, the base/time calculating unit 123 outputs the information of the base computer 20 of the base (x) selected as the software deployment destination and the information of the selected time interval (t) to the software distributing unit 130.

The software distributing unit 130 distributes the feature information of the search target included in the target data designation information acquired by the information acquiring unit 110 and the software for data analysis of the search target to the base computer 20 of the selected base (x). In addition, the software distributing unit 130 transmits an instruction for analysis of data at the selected time (t) to the base computer 20 of the selected base (x).

In a case of a state in which the base/time calculating unit 123 has already completed transmission of the feature information of the search target and the software for data analysis to the selected base computer 20 and the base computer 20 has stored the software for the predetermined time interval, the software distributing unit 130 may be configured not to transmit the feature information of the search target and the software.

In addition, in a case in which the base computer 20 employs a logic for deleting the distributed software as triggered by reception of information indicating the end of a series of processes for the search target (ending information) as a predetermined software deletion logic, the software distributing unit 130 transmits the ending information to each base computer 20 to which the tsoftware has been distributed until then as triggered by finding of the target data.

By configuring as such, in a case in which finding of data of a search target having no result data is performed, the software placement device 10 can efficiently deploy software used for data analysis in the base computer 20 by taking a data presence probability and a cost (the computational cost and the network cost) into account.

Flow of Process

Next, the flow of the process performed by the software placement device 10 according to this embodiment is described.

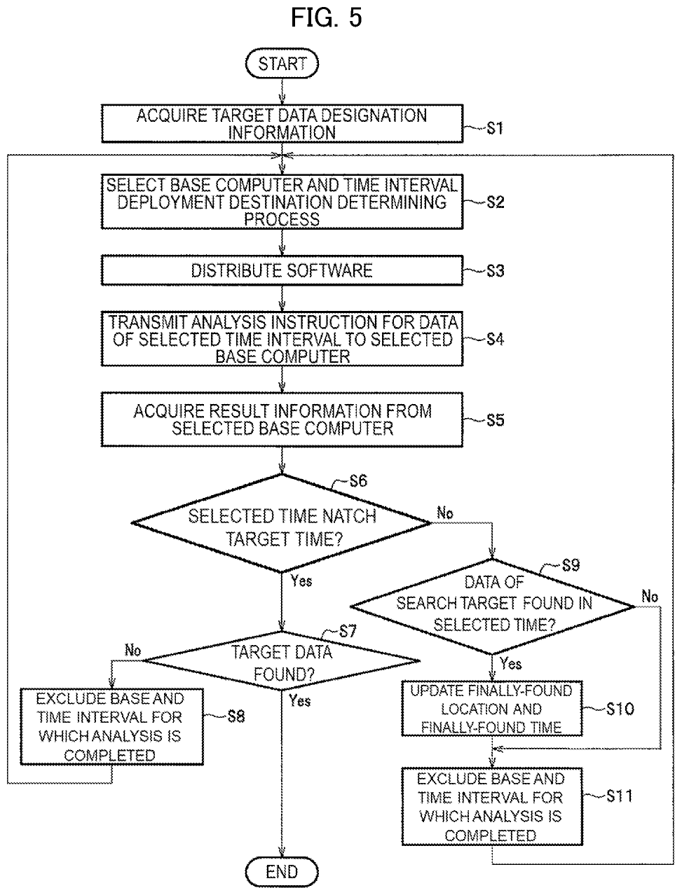

FIG. 5 is a flowchart illustrating the flow of a process of the software placement device 10 according to this embodiment.

It is supposed that the location information of each of the base computers 20 and the computational cost (Cc) and the network cost (Cn) for each of the base computers 20 are stored in the base information DB 500 inside the storage unit 150 of the software placement device 10. In addition, it is supposed that information of the deviation time interval (t_max), the constant (the weight “a”) used for calculation of the data presence probability, and the constant (the weight “β”) used for calculation of the total cost are stored in the storage unit 150 in advance.

First, the information acquiring unit 110 of the software placement device 10 acquires designated information of target data that is a search target (target data designation information) from an external apparatus (for example, a network management apparatus or the like) (step S1).

This target data designation information includes feature information of a search target and information of a target time interval, a finally-found location, and a finally-found time.

Next, the deployment destination determining unit 120 of the software placement device 10 selects a base computer 20 and a time interval that is a search target of a base for which the cost is a minimum by using parameters such as “data presence probability”, “data value”, “data expectation value”, “total cost” and the like (step S2: deployment destination determining process).

More specifically, the data presence probability calculating unit 121 calculates a data presence probability using the information of the finally-found location and the finally-found time of the search target. Then, the data expectation value calculating unit 122 calculates a data expectation value based on the data presence probability calculated by the data presence probability calculating unit 121 and the data value obtained using the target time interval and the deviation time interval. In a case in which the data value is not used, the data expectation value calculating unit 122 sets the value of the data presence probability as a data expectation value. Subsequently, the base/time calculating unit 123 calculates a total cost based on the data expectation value calculated by the data expectation value calculating unit 122 and the computational cost and the network cost for each of the base computers 20 and selects a base (the base computer 20) and a time interval that is a search target for which base and time interval the total cost is a minimum.

Next, the software distributing unit 130 of the software placement device 10 distributes the feature information of the search target included in the target data designation information acquired in step S1 and the software used for analyzing data of the search target to the base computer 20 selected in step S2 (step S3: software distribution).

Subsequently, the software distributing unit 130 of the software placement device 10 transmits an instruction for analyzing data of the time interval selected in step S2 to the selected base computer 20 (step S4). This causes the base computer 20 to perform a search for determining whether or not the search target is able to be be found in the selected time interval of the stored data 200 (FIG. 1).

The software placement device 10 may transmit the software in step S3 and the analysis instruction in step S4 to the selected base computer 20 not separately but via one message. Alternatively, in a case in which the process of step S2 is to be repeated and the feature information of the search target and the software for data analysis have been already distributed to the base computer 20 that has been selected once and have not been deleted, the process of step S3 can be omitted.

Next, the deployment destination determining unit 120 of the software placement device 10 acquires result information indicating whether or not data (found data) including the search target is found in the selected time interval from the selected base computer 20 (step S5).

Subsequently, the deployment destination determining unit 120 of the software placement device 10 determines whether or not the time interval selected in step S2 matches the target time interval acquired in step S1 (step S6).

Here, when the selected time interval and the target time interval match each other (Yes at step S6), the process proceeds to the next step S7.

In step S7, the software placement device 10 determines whether not the target data is able to be found based on the result information acquired in step S5.

Here, in a case in which the target data is able to be found (Yes at step S7), the software placement device 10 ends the process. On the other hand, in a case in which the target data is not able to be found (No at step S7), the software placement device 10 excludes the selected time interval in the selected base computer 20 from next selection candidates as an analyzed time interval (step S8). Then, the software placement device 10 returns the process to step S2 to continue the process.

On the other hand, in a case where the selected time interval and the target time interval do not match each other in step S6 (No at step S6), the process proceeds to the next step S9.

In step S9, the software placement device 10 (the deployment destination determining unit 120) determines whether or not data including the search target is found in the selected time interval (a time interval different from the target time interval).

Here, in a case in which data including the search target is found in the selected time interval (a time interval different from the target time interval) (Yes at step S9), the deployment destination determining unit 120 of the software placement device 10 updates the finally-found location of the search target with the location of the selected base computer 20 and updates the finally-found time of the search target with a time of the data found in the selected time interval (a time interval different from the target time interval) (step S10).

On the other hand, in a case in which data including the search target is not been found in the selected time interval (the time interval different from the target time interval) in step S9 (No at step S9), the software placement device 10 causes the process to proceed to step S11.

In step S11, the software placement device 10 determines the selected time interval (the time interval different from the target time interval) in the selected base computer 20 to be in an analysis-completed state and excludes the selected time interval from the next selection candidates. Then, the software placement device 10 returns the process to step S2 to continue the process.

In this way, the software placement device 10 according to this embodiment is able to update the data presence probability with the data being found. Thus, even for a search target having no result data, the software placement device 10 is able to efficiently deploy the software used for data analysis to base computers 20 taking into account a computational cost and a network cost.

Hardware Configuration

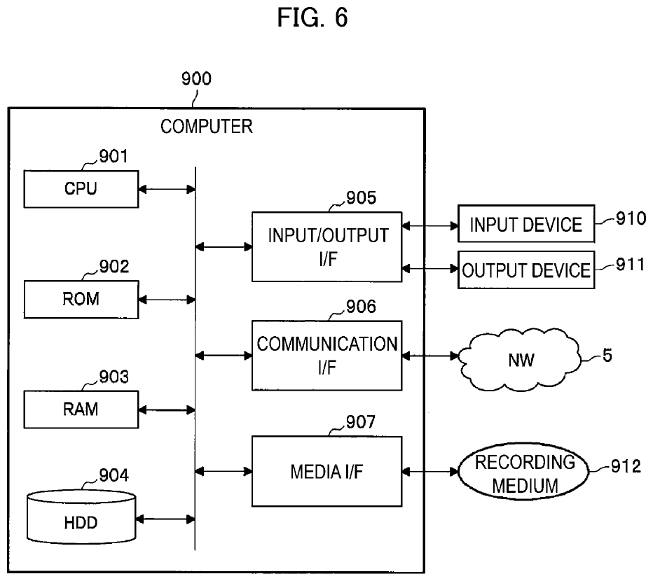

The software placement device 10 and the base computer 20 according to this embodiment are, for example, implemented using a computer 900 having a configuration as illustrated in FIG. 6.

FIG. 6 is a hardware configuration diagram illustrating an example of the computer 900 that implements functions of the software placement device 10 and the base computer 20 according to this embodiment. The computer 900 includes a CPU 901, a read only memory (ROM) 902, a RAM 903, a hard disk drive (HDD) 904, an input-output interface (I/F) 905, a communication I/F 906, and a media I/F 907.

The CPU 901 operates based on a program stored in the ROM 902 or the HDD 904 and performs control under the control unit 100 of the software placement device 10 illustrated in FIG. 1 and a control unit (not illustrated) of the base computer 20. The ROM 902 stores a boot program that is executed by the CPU 901 when the computer 900 is activated, a program for a hardware of the computer 900, and the like.

The CPU 901 controls an input apparatus 910 such as a mouse and a keyboard, and an output apparatus 911 such as a display and a printer through the input-output I/F 905. Through the input-output I/F 905, the CPU 901 acquires data from the input apparatus 910, and outputs the generated data to the output apparatus 911. A graphics processing unit (GPU) or the like may be used together with the CPU 901 as processors.

The HDD 904 stores a program executed by the CPU 901, data used by the program, and the like. The communication I/F 906 receives data from another apparatus through a communication network (for example, the network (NW) 5) and outputs the received data to the CPU 901 and transmits data generated by the CPU 901 to another apparatus through the communication network.

The media I/F 907 reads a program or data stored in a recording medium 912 and outputs the program or the data to the CPU 901 through the RAM 903. The CPU 901 loads a program for an intended process from the recording medium 912 through the media I/F 907 onto the RAM 903, and executes the loaded program. The recording medium 912 is a medium such as an optical recording medium such as a digital versatile disc (DVD) and a phase change rewritable disk (PD), a magneto-optical recording medium such as a magneto optical disk (MO), a magnetic recording medium, a conductor memory tape medium, a semiconductor memory, and the like.

For example, when the computer 900 functions as the software placement device 10 and the base computer 20 according to this embodiment, the CPU 901 of the computer 900 implements the functions of the software placement device 10 and the base computer 20 by executing a program loaded on the RAM 903 placement device. In addition, the HDD 904 stores data in the RAM 903. The CPU 901 reads a program for an intended process from the recording medium 912 to execute it. Furthermore, the CPU 901 may read the program relating to the intended process from another apparatus through the communication network (NW 5).

Effects

Hereinbelow, effects of the software placement system and the like according to the present invention is described.

A software placement system according to the present invention is a software placement system 1000 including: base computers 20 respectively located in a plurality of areas; and a software placement device 10 configured to deploy software for analyzing data collected from devices 2 inside the areas in the base computers 20, wherein the software placement device 10 includes: an information acquiring unit 110 configured to acquire a finally-found location indicating a location at which a search target is last found and a finally-found time indicating a time at which the search target is last found; a deployment destination determining unit 120 configured to calculate a data presence probability indicating a probability of the search target being detected in the data at a certain time using the finally-found location and the finally-found time, to calculate a total cost using the calculated data presence probability and a computational cost and a network cost of each of a plurality of the base computers, and to select a base computer 20 and a time interval for searching for the search target for which the calculated total cost is a minimum; and a software distributing unit 130 configured to distribute the software to the selected base computer 20 and to transmit an analysis instruction for data of the selected time interval and thereby to cause the selected base computer to execute a search for the search target in the selected time interval, and wherein each of the base computers 20 includes: a data collecting unit 22 configured to collect data from the devices 2 inside the area; and a data analyzing unit 21 configured to execute the search for the search target for the data of the selected time interval indicated in the analysis instructionusing the software when the software is distributed to the corresponding base computer.

Alternatively, a software placement device according to the present invention is a software placement device 10 configured to deploy software for analyzing data in base computers 20 collecting the data from devices 2 inside predetermined areas, the software placement device including: an information acquiring unit 110 configured to acquire a finally-found location indicating a location at which a search target is last found and a finally-found time indicating a time at which the search target islast found; a deployment destination determining unit 120 configured to calculate a data presence probability indicating a probability of the search target being detected in the data at a certain time using the finally-found location and the finally-found time, to calculate a total cost using the calculated data presence probability and a computational cost and a network cost of each of a plurality of the base computers 20, and to select a base computer 20 and a time interval for searching for the search target whose calculated total cost is a minimum; and a software distributing unit 130 configured to cause the selected base computer to execute a search for the search target in the selected time interval by distributing the software and transmitting an analysis instruction for data of the selected time interval to the selected base computer 20.

In this way, the software placement device 10 of the software placement system 1000 is able to calculate a total cost using the data presence probability based on the finally-found location and the finally-found time, and a computational cost and a network cost of each base computer 20 and to deploy software at a base computer 20 for which the calculated total cost is a minimum.

Thus, even for a search target for which past result data cannot be used, the software placement device 10 can efficiently deploy the software used for data analysis.

In addition, in the software placement device 10, the information acquiring unit 110 additionally acquires information of a target time interval designating a time interval in which the search target is found, and, in a case in which the selected time interval and the target time interval do not match each other, upon acquiring from the selected base computer 20 result information indicating that the search target is found through a search for data of the selected time interval, the deployment destination determining unit 120 updates the finally-found location with a location of the selected base computer 20 and updates the finally-found time with the selected time interval.

In this way, in a case in which a search target is found in data in which a selected time interval and a target time interval do not match each other, the software placement device 10 can update the finally-found location with a location of the selected base computer 20 and update the finally-found time with the selected time interval. This allows the software placement device 10 to select a base computer 20 that is a new deployment destination by updating the data presence probability. Thus, the software placement device 10 is able to further raise a possibility of data of a search target being able to be found.

In addition, in the software placement device 10, the information acquiring unit 110 additionally acquires information of a target time interval designating a time interval in which the search target is to be found, and the deployment destination determining unit 120 calculates a data expectation value including into the calculated data presence probability a data value that is an index decreasing as a difference between a certain time interval and the target time interval increases and calculates the total cost using the calculated data expectation value and a computational cost and a network cost of each of a plurality of the base computers 20.

In this way, the software placement device 10 is able to calculate the total cost with the data value taken into account in addition to the data presence probability and the computational cost and the network cost of each base computer 20. This data value prevents simply selecting only data having a high data presence probability because a value of data at a time further apart from the target time is relatively lowered (a value of data closer to a target time is relatively higher). Thus, the software placement device 10 is able to reduce the number of times of data processing, and the software used for data analysis is able to be deployed more efficiently.

In another aspect, a base computer according to the present invention includes: a data collecting unit 22 configured to collect data from devices inside its area; and a data analyzing unit 21 configured to accept, upon receiving distribution of software for analyzing the data, an analysis instruction of data at a selected time interval out of the collected data and execute a search for a search target for the data of the selected time interval using the software.

In this way, the base computer 20 can receive and store software only when data analysis is required and perform data analysis on only data of a time interval for which an analysis instruction is received. Thus, the computational load of the base computer 20 is able to be reduced.

Note that the present invention is not limited to the embodiment described above, and various modifications can be made by those skilled in the art within the technical idea of the present invention.

### REFERENCE SIGNS LIST

2: Device
10: Software placement device
20: Base computer
21: Data analyzing unit
22: Data collecting unit
23: Software deleting unit
100: Control unit
110: Information acquiring unit
120: Deployment destination determining unit
121: Data presence probability calculating unit
122: Data expectation value calculating unit
123: Base/time calculating unit
130: Software distributing unit
140: Input/output unit
150: Storage unit
200: Data
500: Base information DB
1000: Software placement system

1. A software placement system comprising:
base computers located respectively in a plurality of areas; and
a software placement device configured to deploy in the base computers software for analyzing data collected from devices inside the areas,
wherein the software placement device includes:
an information acquiring unit, including one or more processors, configured to acquire a finally-found location indicating a location at which a search target is last found and a finally-found time indicating a time at which the search target is last found;
a deployment destination determining unit, including one or more processors, configured to calculate a data presence probability indicating a probability of the search target being detected in the data at a certain time using the finally-found location and the finally-found time, to calculate a total cost using the calculated data presence probability and a computational cost and a network cost of each of the base computers, and to select a base computer and a time interval for searching for the search target for which the calculated total cost is a minimum; and
a software distributing unit, including one or more processors, configured to distribute the software to the selected base computer and transmitting an analysis instruction for data at the selected time interval to cause the selected base computer to execute a search for the search target in the selected time interval, and wherein
each of the base computers includes:
a data collecting unit, including one or more processors, configured to collect data from devices inside the area; and
a data analyzing unit, including one or more processors, configured to execute a search for the search target using the software for the data of the selected time interval indicated in the analysis instruction when the software is distributed to the corresponding base computer.

2. A software placement device configured to deploy software for analyzing data into base computers collecting the data from devices inside predetermined areas, the software placement device comprising:
an information acquiring unit, including one or more processors, configured to acquire a finally-found location indicating a location at which a search target is last found and a finally-found time indicating a time at which the search target is last found;
a deployment destination determining unit, including one or more processors, configured to calculate a data presence probability indicating a probability of the search target being detected in the data at a certain time using the finally-found location and the finally-found time, to calculate a total cost using the calculated data presence probability and a computational cost and a network cost of each of a plurality of the base computers, and to select a base computer and a time interval for searching for the search target for which the calculated total cost is a minimum; and
a software distributing unit, including one or more processors, configured to cause the selected base computer to execute a search for the search target in the selected time interval by distributing the software to the selected base computer and transmitting an analysis instruction for data of the selected time interval.

3. The software placement device according to claim 2,
wherein the information acquiring unit is further configured to acquire information of a target time interval designating a time interval in which the search target is to be found, and
wherein, when the selected time interval and the target time interval do not match each other, the deployment destination determining unit is configured to update the finally-found location with a location of the selected base computer and update the finally-found time with the selected time interval upon acquiring from the selected base computer result information indicating that the search target is found through a search of data at the selected time interval.

4. The software placement device according to claim 2,
wherein the information acquiring unit is further configured to acquire information of a target time interval designating a time interval in which the search target is to be found, and
wherein the deployment destination determining unit is configured to calculate a data expectation value including in the calculated data presence probability a data value that is an index decreasing as a difference between a certain time interval and the target time interval increases; and calculate the total cost using the calculated data expectation value and a computational cost and a network cost of each of a plurality of the base computers.

5. A software placement method of a software placement device configured to deploy software for analyzing data at base computers collecting the data from devices inside predetermined areas, the software placement method comprising, at the software placement device:
acquiring information of a finally-found location indicating a location at which a search target is last found and a finally-found time indicating a time at which the search target is last found;
calculating a data presence probability indicating a probability of the search target being detected in the data at a certain time using the finally-found location and the finally-found time, calculating a total cost using the calculated data presence probability and a computational cost and a network cost of each of the base computers, and selecting a base computer and a time interval for searching for the search target for which the calculated total cost is a minimum; and
causing the selected base computer to execute a search for the search target in the selected time interval by distributing the software to the selected base computer and transmitting an analysis instruction for data in the selected time interval.

6. A base computer comprising:
a data collecting unit, including one or more processors, configured to collect data from devices inside an area; and
a data analyzing unit, including one or more processors, configured to accept, upon receiving distribution of software for analyzing the data, an analysis instruction for data of a selected time interval out of the collected data and execute a search for a search target for the data of the selected time interval using the software.

7. A computer-readable storage medium storing instructions for executing a program for causing a computer to function as the software placement device according to claim 2.

8. A computer-readable storage medium storing instructions for executing a program causing a computer to function as the base computer according to claim 6.
